(19) United States
(12) Patent Application Publication
(10) Pub. No.: US 2025/0259240 A1
(43) Pub. Date: Aug. 14, 2025

(54) FINANCIAL MILESTONES AND PAYOUT SYSTEM

(71) Applicant: TRADING GAMES, INC., FRANKLIN SQUARE, NY (US)

(72) Inventors: JOSEPH G. WILLIAMS, FRANKLIN SQUARE, NY (US); CHRISTIAN STUCCHIO, JERSEY CITY, NJ (US); DAVID KURIAKOSE, OLD WESTBURY, NY (US)

(73) Assignee: TRADING GAMES, INC., FRANKLIN SQUARE, NY (US)

(21) Appl. No.: 19/193,786

(22) Filed: Apr. 29, 2025

Related U.S. Application Data
(63) Continuation of application No. 18/480,921, filed on Oct. 4, 2023.
Application No. 18/480,921 is a continuation of application No. 17/363,234, filed on Jun. 30, 2021, now abandoned.
Application No. 17/363,234 is a continuation of application No. 16/057,275, filed on Aug. 7, 2018, now abandoned.
Application No. 16/057,275 is a continuation of application No. 15/195,038, filed on Jun. 28, 2016, now abandoned.
Application No. 15/195,038 is a continuation of application No. 13/780,971, filed on Feb. 28, 2013, now abandoned.
Application No. 13/780,971 is a continuation of application No. 13/301,044, filed on Nov. 21, 2011, now abandoned.
(60) Provisional application No. 61/415,369, filed on Nov. 19, 2010.

(51) Int. Cl. G06Q 40/06; G06Q 20/10

(52) U.S. Cl. CPC G06Q 40/06; G06Q 20/10

(57) ABSTRACT

An platform for contingent fundraising includes a method, system, system architecture that efficiently allows businesses to establish milestones and offer a liability based on an offered interest rate and a target amount of funds to raise. Funders using the system can match the business' offer with funding to meet the target raise. Funds commensurate with the liability and a funder's offer are provided by participants and isolated by the system until the milestone is evaluated. Funds are distributed to the business or funders based on the milestone status.

### RELATED APPLICATIONS

This application is a continuation of U.S. patent application Ser. No. 18/480,921 filed Oct. 4, 2023 which is a continuation of U.S. patent application Ser. No. 17/363,234 filed on Jun. 30, 2021, which is a continuation of U.S. patent application Ser. No. 16/057,275 filed Aug. 7, 2018, which is a continuation of U.S. patent application Ser. No. 15/195,038 filed Jun. 28, 2016, which is a continuation of U.S. patent application Ser. No. 13/780,971 filed Feb. 28, 2013, which is a continuation of U.S. patent application Ser. No. 13/301,044 filed on Nov. 21, 2011, and which claims priority under 35 U.S.C. § 119 (e) to U.S. Provisional Patent Application Ser. No. 61/415,369. The entirety of each of the above-listed applications are incorporated herein by reference.

### BACKGROUND

Every year, billions of dollars are invested to fund the development of new and growing businesses in America. Despite these substantial investments, a significant portion of funding goes to a relatively small percentage of businesses, with many companies never receiving sufficient capital to operate and grow. Traditional investment funds tend to focus their resources on companies with the highest potential for growth, while generally ignoring companies which, despite having potential for profit, are deemed less likely to produce outsized returns.

Several factors are considered by investors when deciding whether to fund a business. For example, an investor may consider the history of the business or the background of the entrepreneur, including education, experience, or previous ventures. Also in consideration may be the company's management team, the sector of industry targeted, and various other factors that may affect the company's potential for growth and profit.

For investors that invest in privately held firms, rather than publically traded firms, their investments are generally not liquid. Instead, the capital is needed by the business to grow and develop, and investors cannot redeem their holdings for cash to for several years. Investors may receive a return on their investment if the business goes public, in which case investors can sell their shares on a secondary market after the insider lockup period, or directly to another entity that may acquire the business.

When an investment is made, the investor may obtain ownership of part of the company, and may expect to have some control over the business, such as being a member of the board of directors. Investors may consist of private individuals, accredited “angel” investors, corporations, institutional investors, or larger pools of funds gathered from many sources and organized, for example, by private equity or venture capital funds.

Investment funds typically gather investments from several funding sources and determine the companies in which to invest the aggregated funds. These funds may establish certain agreements with their Limited Partners to restrict their investment activity and percentage of allocation per deal type, while requiring a capital return within a finite amount of time. This causes conflicting interests between the Partnership and the businesses or entrepreneur. On one hand, the general partners' fiduciary responsibility to meet returns above the S&P to compensate Limited Partners for the illiquid nature of their fund structure may obligate them to replace the business management or force an exit. For entrepreneurs, such actions may not be aligned with their own goals for the business.

When a manager of the fund does decide to exit from the business, any capital recovered from the exit may be redistributed to investors on a pro-rata basis, for example, depending on the relative amount of each investor's contribution. Alternatively, in some limited partnerships, the funds may instead be re-invested into the business and any returns may not be realized until the end of the fund. As a result, many investors tend to seek high-risk, high-reward companies that offer the chance of large profit in return for a lengthy investment period.

To help achieve those long-term goals, businesses and/or investors often seek the guidance of third-party experts. For example, businesses may rely on experts in financial planning, business development, sales and marketing, or industrial technology to provide skillsets that help guide the direction and expectations of the company. For example, a financial expert may provide feedback on financial projections, capital required to achieve those financial projections, exit strategies, risk assessment, or various other matters that affect both day-to-day and long-term operation of the company.

### SUMMARY

A fundraising platform is provided to allow businesses, funders, and experts to interact and participate in crowd-sourced capitalization of businesses. Businesses may be awarded funding by achieving skill-based milestones using actionable information from experts. Funders may receive a portion of revenue from businesses that achieve milestones, and may receive an interest on capital from businesses that fail to achieve milestones. Experts may receive a fee for services rendered in helping businesses.

Businesses may establish a royalty contract structure, which may specify a royalties to pay to funders when the business successfully achieves milestones, under the condition that the business has a revenue exceeding a threshold. The business may, in conjunction with experts, generate milestones which may establish a target raise, conditions for royalty payouts based on amount of funding, and an offered interest rate. The business may establish a long side of the milestone by providing a liability based on the offered interest rate and raise.

The milestone may be broadcast to funders, for example, using a broadcast medium to display information regarding the business and the offered milestone. The funders may then decide whether to accept a short side of the milestone by matching the business' liability with funding to reach the target raise. Alternatively, the funders may offer their own interest rate and corresponding funds, which the business may then accept and match with money to cover the offered interest rate.

Upon reporting the outcome of the milestone, the platform may establish specifications to distribute the liability, the funding, and the royalty among the business, the experts, and the funders. If the business successfully achieves the milestone, then the business may receive a portion of the funding, while the funders may receive a portion of the royalty shares. Alternatively, if the business does not achieve the milestone, the funders may receive back their funding plus interest in the form of the business' liability.

The platform may also create pools of businesses, in which all companies in the pool of companies may receive funding for achieving certain milestones. Alternatively, the pool of businesses may operate as a competitive pool in which only a few companies receive funding, according to any suitable criteria of competition.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 shows an illustrative embodiment of a computer-implemented system to provide a fundraising platform for businesses, experts, and funders.

FIG. 2 shows an illustrative embodiment of a flowchart of a computer-implemented method to operate a fundraising platform.

FIG. 3 shows an illustrative embodiment of a flowchart of a computer-implemented method to establish a royalty share issuance for a business.

FIG. 4 shows an illustrative embodiment of a flowchart of a computer-implemented method to establish a milestone for a business.

FIG. 5 shows an illustrative embodiment of a flowchart of a computer-implemented method to obtain funding from funders for the business.

FIG. 6 shows an illustrative embodiment of a flowchart of a computer-implemented method to establish payouts to businesses, experts, and funders.

FIGS. 7A-7C show an illustrative embodiment of a portion of a computer-implemented user interface for funders to select a business to fund.

FIG. 8 shows a computer system on which some embodiments of the invention may be implemented;

FIG. 9 shows a networked computer system having components that may be used by some embodiments of the invention to provide a fundraising platform; and

FIGS. 10A-10C show an illustrative flowchart illustrating a particular method according to one aspect of the invention and further showing the use of various vault accounts.

### DETAILED DESCRIPTION

The inventors have recognized and appreciated that potential opportunities for innovation and new product financing may be better realized by providing a milestone-based contingent fundraising platform. Such a platform may be used, as an example, for crowd-funded milestone contests with entry fees acceptable by law. In some embodiments, the platform may reward a contestant for successfully growing a business. The contestants may be entrepreneurs developing a company, who may be rewarded with capital if they achieve skill-based milestones. The capital may be provided through crowd-sourced funding as the prize money. The platform may combine a capital raising facility with actionable information from industry experts. Those experts may select the businesses and provide information to the business. Funding may be awarded to a contestant whose company achieves milestones, and a portion of the company's future gross sales or revenue may be provided to the funders for a preset duration of time as long as the business surmounts targeted productivity hurdles.

The milestones may be quantitative and/or qualitative depending on the criteria set for the business to achieve. In some embodiments, the payments of future royalty may not apply unless the target amount of top-line revenue is achieved. As such, the royalty payments may not be directly associated with a specific milestone goal. Nonetheless, in some embodiments, a milestone goal may be positioned to directly correspond with a revenue hurdle.

The contestants may designate one or more experts, such as a media or institution, as a trusted contest settler to host the contest. The funding crowd may also accept that same expert. In some embodiments, the expert may provide a skillset in any suitable field, such as financial planning, business development, or sales and marketing. In embodiments where the crowd offers prize money, the crowd may offer the contest. In such embodiments, the experts may be a broadcast mechanism and outcome decider. Such a platform may provide funders with returns as the contestant's business grows by achieving its milestones, with or without an exit. For the contestants and their businesses, crowd-sourced funding may reduce the ownership given away to capitalize their businesses.

In some embodiments, the platform may be a royalty-on-revenue contract exchange platform. In such embodiments, if the contestant achieves a milestone, it may relinquish a portion of its potential revenue as shares of a royalty. If the company loses the contest, then it may pay the cost of placing the contract, which may be the amount of interest due on the expiration date which depends on the target amount of money to raise that was matched. In some embodiments, the transfer of the royalty shares or money may be considered an entry fee.

More generally, the platform may also be applied to various equity, convertible, or debt instruments, as long as proper licensing, certification, and eligibility requirements are met per jurisdiction. The platform may also be implemented with any appropriate currency-based unit, real or virtual, as long as users once ascribed value to it. In general, however, the currency that is funded to companies and paid to the funders may be any fungible good.

Experts with proven experience may help the contestants set milestones and determine the amount of funding needed to earn by achieve those milestones. For example, financial planning advisors may provide information to the business regarding a projected amount of funding required to achieve a milestone. Furthermore, the experts may have exposure or influence on potential businesses users, while simultaneously providing social proof that a contestant may be less risky. In some embodiments, the experts may earn compensation once the contestant performs well. For example, the experts may earn a percentage of each funding raise and a performance fee from profits generated for the funders. More generally, the experts may be compensated based on any appropriate means based on the performance of the contestant's business. In some embodiments, the expert may be compensated only if the expert's service is deemed appropriate by a group of funders, for example, those providing the largest portion of funds. Therefore, it may be in the experts' interest to guide the contestant in setting milestones that are value additive to the contestant's overall business success.

Such a crowd-funded contest platform may help make the fund-raising process turnkey by making available more real-time public capital. In some embodiments, this fund-raising may be provided for private entities or public entities, or in general any entity that can make revenue, including not-for-profits. The platform may allow a wide variety of potential investors to fund businesses selected by the experts. In some embodiments, a contest platform may be provided to allow experts to raise pledge pools to allocate at their discretion to contestant businesses they select. Such businesses may include, for example, noncyclical businesses with predictable growth, or high margin cyclical businesses early in the business cycle that may produce returns quickly. In general, however, the selected businesses may be any suitable business selected by the experts according to any suitable criteria.

Traditionally, the availability of general partners in a traditional venture capital fund may limit the amount of deals that the firm can do. Thus, even if venture capitalists encounter an attractive business opportunity, their money may already be tied up in long-term investments. The inventors have recognized and appreciated that a crowd-funded milestone-based fundraising platform may allow investors to earn compensation without having to lock in their resources for extended time, and may attract a wider variety of investors, not just the wealthy accredited investors. Furthermore, the inventors have recognized and appreciate that for contestants and their businesses, embodiments of such a platform may allow entrepreneurs to obtain capital directly from public funders without having to give up control of their businesses.

In some embodiments, the crowd-funded contest platform may allow for the distribution of the businesses selection and guidance process to a multitude of relevant experts. There may be many capable experts that may be compensated and incentivized without the necessary bundling of preferred equity injection. Alternatively or additionally, the platform may increase the number of potential funding participants to effectively reduce the funding size per subscription, thereby eliminating the need for many costly protective provisions, board participation, and/or transfer of ownership.

In some embodiments, contestants that participate in the contest platform may legally repay funders with consumable goods, such as cash returns. As such, the platform may build partnerships with day trading, wealth manager, brokers, open and close end funds, investment companies, and/or foreign exchange companies to increase funding volume through their deposit bases. Furthermore, the platform may partner with banks, venture, and angel groups. These groups may turn away potential investment opportunities while referring them to the platform's experts. As contestants of the platform, if those businesses go on to raise capital, then the investment groups or banks may be compensated even from businesses that they do not work with directly.

In some embodiments, if funders sell their shares of royalties to non-accredited investors, then the platform may be deemed an investment platform. Alternatively, if there is enabled a secondary market for royalty shares, then the platform may allow the royalties to be purchased by accredited investors or qualified institutions.

In some embodiments, such a fundraising platform may be complementary to other forms of capitalization, for example, as a means to fill-out funding rounds during various stages of an investment process. As many small equity investments lack liquidity, such a platform may be, in some embodiments, coupled with an illiquid equity investment. The purpose of this may be, for other reasons, to help liquidate money for those who have invested in equity as well.

In some embodiments, a businesses may allow its employees to contribute a portion of their salary into funding for a milestone the entire company is trying to achieve by a deadline, which may 3-6 months or any other suitable time period. If the business hits this milestone, then the employees who contributed may share in the revenue. If the business doesn't achieve the milestone, then the employees get the money they let the business withhold back with an interest rate was agreed upon in case of failure. In some embodiments, this may be cheaper for the business than a stock option, since they can expense the payments of future royalties.

In yet other embodiments of using the fundraising platform, the business may charge a premium price for their products and may apply the extra cost directly towards funding a milestone. For example, the platform may raise capital for a brewery, which may attempt to attract funders by producing special bottled beer that costs 20% more, but offers the possibility of future royalty payments if a customer enters a code printed under the bottle cap into the customer's platform profile page.

In some embodiments, the platform may include an engine that is an exchange for zero-sum semantic contracts, for example a binary derivative, which may be based on the expectation of a future event. Users may take “agree” (long) or “disagree” (short) positions at any probability. Outcome reports by operators serve to clear trade positions and subsequently can be tied to any underlying occurrence. The system may let users enter into and offset liability of these contracts.

In some embodiments, users may, additionally or alternatively to taking positions on outcomes they cannot influence, also challenge peers directly or pledge to complete a task on odds-based incentive payouts. The engine may be funded with any fungible unit or currency, either real or virtual. Additionally, currencies may be issued, funded, destroyed and/or accounted for by the engine based on true or false events reported to the system.

Contests that use virtual currencies or stackable items may, in some embodiments, tie their connected platform into the engine, thereby enabling their players to take positions with that contest's virtual currency. Additionally or alternatively, users may take positions with any fungible unit or currency external to the contest world, for head-to-head play in that contest or based on the outcomes of mini-contests and quests within a persistent virtual world.

In some embodiments, unlike bookmakers or market makers, experts who may be acting as operators may avoid taking any positions by offering a spread and risking loss exposure because of upsets or unanticipated global macroeconomic occurrences. Instead, the platform may match each user's position against other users.

In some embodiments, the engine may distinguish users into different classes of users including, but not limited to, businesses who may create long (agree) event futures, and funders who may execute short (disagree) orders. In such embodiments, the input for odds may be either an interest rate, allowing the system to output an amount of liability to risk when a business creates a milestone on the long side, or an amount demanded for failure, allowing the system to output an amount of funding on the short side for a funder to receive back that amount in addition to the calculated output in case of failure.

Outcome responses may be considered an event which can influence an amount granted. The relevant event that may affect the engine is when an expert, for example acting as an operator, indicates whether an event occurred. If an outcome report indicates an event did occur, then the currency of royalty shares may be granted to any funders on the short side.

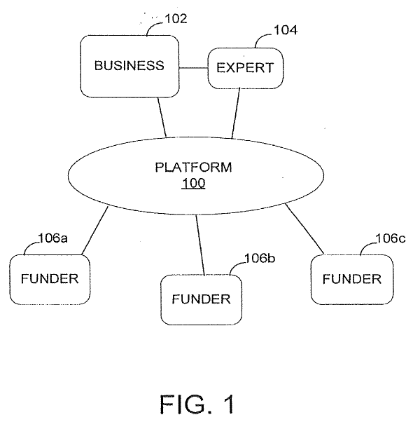

FIG. 1 illustrates an exemplary system in which a fundraising platform 100 may operate. In this example, the system may be a network of computers operated by different users, all interacting through the platform 100. In this example, three types of users are shown: businesses, experts, and funders. The exact number and names of these users, however, are not critical to this invention. In some embodiments, for example, an expert may also be a funder. Furthermore, in some embodiments, there may be more than one business that may work with multiple experts and may obtain funding from the same or different funders.

A business, such as business 102, is illustrated. The business 102 may be a private or public entity, and may comprise any number of individuals. Examples include, but are not limited to, startup companies, non-profit organizations, or any suitable entity that generates revenue. Although a single business 102 is illustrated, the invention is not limited to any particular number of businesses, and in general, any suitable number of businesses may use the platform 100.

An expert, such as expert 104 is shown, which may provide information and guidance to the business 102. In some embodiments, multiple businesses may apply to the expert 104, who may then select business 102 based on various criteria. Alternatively, in some embodiments, the expert 104 may work with a pool of businesses, which may be grouped, for example, by industry or other suitable common characteristic. In some embodiments, the expert 104 may help determine appropriate milestones for the collective pool of businesses, or for an individual business 102. In establishing these milestones, the expert 104 may provide strategic guidance to the business 102. In some embodiments, the business 102 and the expert 104 may raise funds from various funders to provide capital to implement the strategies.

Funders, such as funders 106a, 106b, and 106c, are shown, although in general there may be any number of funders using the platform 100. Funders 106a, 106b, and 106c may be, for example, individuals, institutions, or any other suitable entity that may invest in business 102 through platform 100.

In some embodiments, the platform 100 may be used as a milestone contest platform. In such cases, the businesses may be contestants competing for funding, the funders may provide the prize, and the experts may settle the contest and report the outcome. In such embodiments, “business 102” may be referred to as “contestant 102” and the two terms will be used interchangeably henceforth.

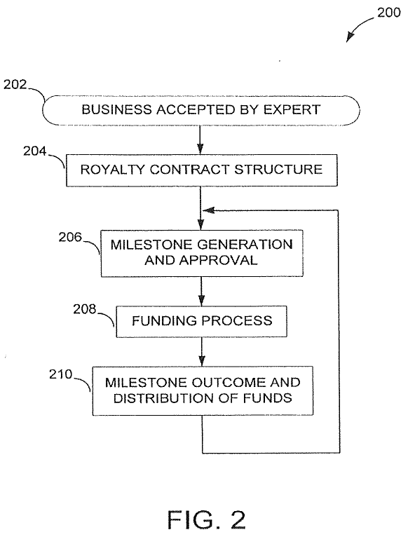

FIG. 2 shows an illustrative embodiment of a flowchart of a method 200 to operate a fundraising platform. In step 202, a business 102 may be accepted by an expert 104 to participate in the fundraising platform 100. In some embodiments, during this initial phase of evaluation, the business 102 may determine if it wants to work with the expert 104 during the future fundraising process. If so, then the business 102 may agree to a fee for services provided by the expert 104, which may be, for example, a percentage of funds raised, or a profit fee.

In step 204, a royalty share issuance may be established for the business 102. In some embodiments, this may determine, among other things, a percentage of revenue to commit to royalty, total number of shares to issue, an amount of time to offer the royalty, and a revenue hurdle at which point royalty payments may be given. In some embodiments, this information may remain the same for different milestones. These determinations may be made by the business 102 in conjunction with the expert 104. Alternatively, there may be any suitable contractual arrangement by the business 102 to determine future royalty payments to funders.

Regardless of the contractual structure of payments between the business, the expert, and the funders, in step 206, the business 102 and expert 104 may work together to raise funds and plan milestones, as well as plan and various other aspects of the fundraising process. In some embodiments, the generation of milestones may be a negotiation between the expert 104 and the business 102. For example, a milestone may be for the business 102 to launch a pilot program in two different cities, with a condition that the expert 104 will provide some skill set in the process. As such, in some embodiments, the milestone may be qualitative, opinion-based, or quantitative.

Regardless of the exact nature of a milestone, in step 208, various funders, such as funders 106a, 106b, and 106c, may decide whether or not to participate in funding the milestone for the business. If the funders decide to participate in the milestone, they may pledge money or goods.

In step 210, the outcome of the milestone may be decided and funds may be distributed among the parties involved in the milestone. In some embodiments, the business 102 may receive funding if it achieves the milestone. In addition, in some embodiments, if the business has exceeded a predefined productivity hurdle, then a royalty may also be provided to the funders. The expert 104 may be paid in a variety of suitable ways. For example, the expert 104 may receive a percentage of the funds raised, a percentage of the royalty payout to funders, or any suitable means.

In some embodiments, the royalty may be, for example, a fraction of some performance-based metric, such as revenue, gross margin, or any line item. The productivity hurdle may also be a performance-based metric, either the same as or different than the metric used to compute royalty. Furthermore, the funding and payout may be any goods or services. For example, the funders may pledge any type of stackable good or service that may be of value to the business 102. Similarly, the royalty payments may be any stackable good or service provided to the funders.

If a fundraising process consists of a pool of businesses, then funding may be determined per business, or collectively for the entire pool of businesses. For example, in some embodiments, if one or more business reach a milestone, then funding may be rewarded to the entire pool, or only to those businesses which achieved the milestone. In some embodiments, the platform may provide for a competition between businesses, wherein only some of the businesses get rewarded at the expense of the other businesses.

Regardless of the exact nature of the distribution of money in step 210, upon completion of a milestone, in some embodiments, the business or pool of businesses may attempt to begin another milestone, using the same royalty contract structure established in step 204. As such, the same revenue hurdle and royalty payment information may apply to different instances of milestone achievement rounds.

Thus, in some embodiments, a milestone may consist of a deadline to calculate interest, and the funders pledging money. If the business 102 reaches the milestone by the deadline, and assuming that the business has a revenue above a threshold, then the business may receive the pledged funding while the funders may receive a royalty based on their respective pledged amounts. If, on the other hand, the business 102 fails to reach the milestone, then the funders may receive back their pledged amount with interest accrued over the duration of the milestone.

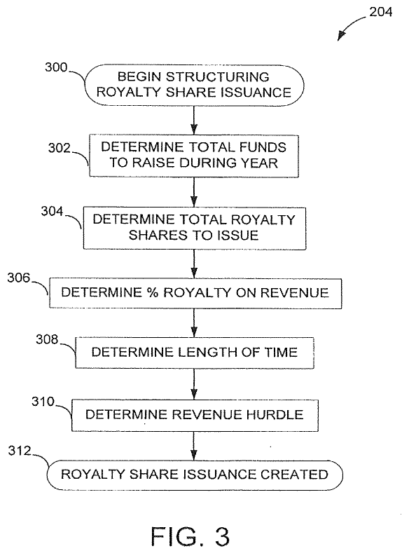

FIG. 3 shows an illustrative embodiment of a flowchart of a computer-implemented method 204 to establish a royalty share issuance for a business. The royalty share issuance may represent information that is used to determine royalty payments offered by a business to funders. In some embodiments, these payments may be realized when the business achieves a milestone, assuming that the business has a revenue exceeding a predefined threshold. Regardless of the specific criteria for determining royalty payouts, in some embodiments, a royalty payout may be made by deducting a portion of the percentage of gross sales or gross revenue at the terms set forth in the issuance.

In step 300, a business may structure a royalty share issuance when it first joins the platform, or once per year, or at any other appropriate time. In step 302, the business may determine the total funds that it plans to raise during the year, or during any suitable time period. Based on this total raise amount, in step 304, the business may determine a total amount of shares to issue. The total issued shares may represent a total amount of royalty issuable, so that whenever a milestone is issued, it deducts from that share total. In some embodiments, if the business creates multiple royalty issuance, those would stack on top of the other one, so that the revenues may aggregate.

From this total issue of shares, the business may determine a percentage of revenue to payout as royalty, as in step 306. The royalty on revenue can be based in any currency (real or virtual) and claims a percentage share of future cash streams from the following categories: top line revenue, EBITDA and EBIT, or gross income. The reported royalty can be specific to a company, particular product line, service, business segment, trademark, patent, or contractual right.

In some embodiments, for example, the percentage of royalty on revenue may represent a percentage of gross sales. Based on this amount of sales, in order to give a target amount of return to the funders, a particular percentage of royalty on revenue may be given away, for a particular amount of time, as shown in step 308. Furthermore, this payment may only apply if the business has exceeded a revenue hurdle. In general, however, the royalty is not limited to revenue, and may be derived from any appropriate measure of productivity, based on any suitable unit or currency.

In step 310, the revenue hurdle may represent a target amount of revenue to achieve in a quarter or any other appropriate time frame. This revenue hurdle, along with the other information used in step 204, may be determined by the business 102 in conjunction with the expert 104. In some embodiments, if the business has multiple issuances to deduct from at once, those may be handled by aggregating a total amount of revenue due, although the number of years and revenue hurdle may be different per issuance.

In some embodiments, the total number of shares issuable may be set as a claim on the royalty chosen. For example, 10,000,000 shares could claim 2% revenue royalty. This percent of revenue may be allocated as a maximum royalty expense, so that selecting 2% of revenue may imply that the yearly royalty expense total can never exceed 2% of the total revenue. Thus, in some embodiments, a fixed percentage of total revenue to payout as royalty may allow businesses to plan for royalty payments as a fixed expense, regardless of the variable nature of milestones that may trigger such payments. Alternatively, there are other embodiments of determining royalty using a quantity other than revenue, for example, using other measures of productivity based on any appropriate fungible unit or currency, either real or virtual.

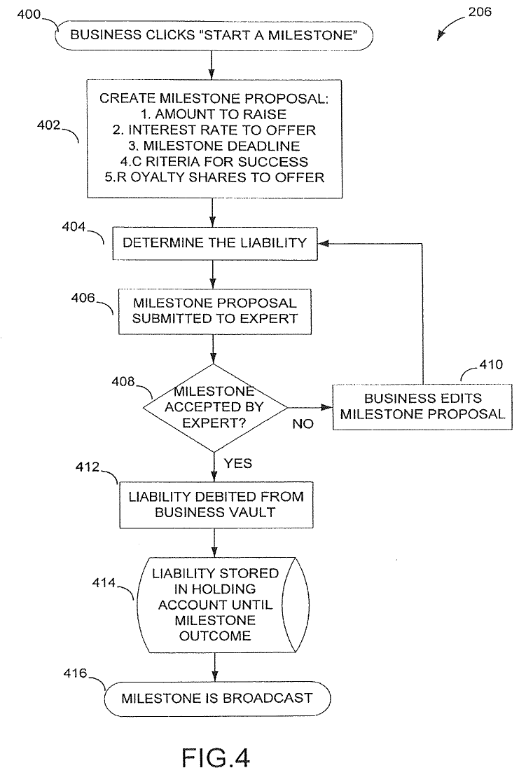

FIG. 4 shows an illustrative embodiment of a flowchart of a computer-implemented method 206 to establish a milestone for a business 102. In step 400, a business may use a computer-implemented interface to submit a desire to start a milestone. This may happen at various stages of the fundraising process, for example, each milestone may represent an effort to raise money in each successive round of funding.

Regardless of the exact motivation for a business 102 creating a milestone, the business may create, in step 402, a proposal for a milestone. In some embodiments, the milestone proposal may include, among other things, a raise, a deadline, and a claim. The raise may be a targeted total amount of funds that the business 102 seeks to receive upon achieving the milestone. In case the business 102 fails to achieve this milestone by the specified deadline, then the interest rate may represent the return on capital provided to the funders for investing their funds with the business 102 during the milestone.

The milestone proposed by the business may also include other information, such as an amount of shares to offer funders upon successful completion of the milestone. In some embodiments, the business 102 may offer royalty shares as a portion of the total issuable shares determined in the issuance, an embodiment of which was shown in step 304 of FIG. 3. For example, continuing the example above, if a business 102 offers a total of 10,000,000 issuable shares, then it can issue 1,000,000 shares for this particular milestone. Depending on the total money the business 102 is raising in the specific milestone, the royalty transferred to funders if the business 102 achieves the milestone may be converted into a percentage of the 1,000,000 offered shares, which is 1/10 of the 2% royalty on revenue.

In some embodiments, the milestone proposal may also contain a criteria for success, to determine exact conditions under which the business 102 is deemed to have achieve the milestone. Such criteria may be, for example, either qualitative or quantitative in nature, and in general may be based on any appropriate measure of performance, as determined by the business 102 and the expert 104. The milestone information may contain any other appropriate information relevant to the establishment of a skill-based criteria for success.

Based on the proposed milestone, in step 404, the platform 100 may automatically determine a liability to put down. This liability may represent a collateral required of the business 102 to participate in the milestone. If the venture is not successful achieving the milestone, the liability may be transferred to the funders to pay them for the opportunity cost of their money not being deployed elsewhere. In some embodiments, the liability may depend on how much money the milestone is intended to raise and the interest rate that the business accepts for the deadline.

For example, in some embodiments, an interest rate may be an input that allows the system to compute an output indicating the amount of liability to risk when a business creates a milestone on the long side. The computed value may depend, for example, on the deadline and the date the milestone becomes active.

Upon creating a milestone proposal, the business 102 may submit the proposal, in step 406, to an expert 104 for approval. In evaluating the proposal, the expert 104 may help determine the appropriateness of various performance goals, such as how long it may take to achieve certain levels of productivity or milestones. Businesses may also use any other third party to help them estimate these metrics, thus providing additional information to determine the milestones and performance hurdles.

In step 408, if the expert rejects the proposal, then the business edits the proposal in step 410, which may happen with the help of the expert. Upon editing the proposal, the business may submit the milestone again for review. Otherwise, if expert approves the milestone in step 408, then the business may proceed to step 412, in which the liability amount is debited from the business 102, and in step 414, stored in a temporary holding account until the milestone outcome is reported.

However, regardless of how the liability is obtained from the business 102, in some embodiments, the approved milestone may be broadcast on the platform in step 416 to begin the fundraising process. The broadcast of the milestone may involve a computer-implemented interface by which a funder may view the details of the business, as well as other information, such as the offered royalty and interest rate. In some embodiments, the approval of the milestone by an expert 104 may also be part of the broadcast, as a way of providing further information and validation to funders regarding the achievability of the milestone and resulting potential benefits to further growth of the business 102.

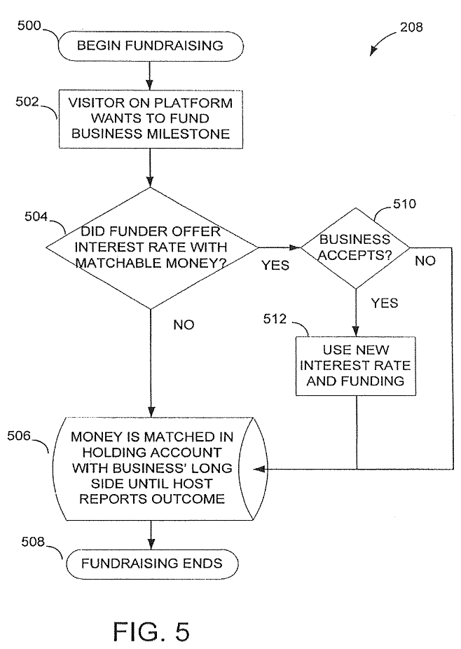

When a user of the platform sees the milestone broadcast and decides to fund the business for the milestone, then a fundraising process may begin. FIG. 5 shows an illustrative embodiment of a flowchart of a computer-implemented method 208 to obtain funding for the business. In step 500, the fundraising process may commence upon broadcast of a milestone, as in step 416 of FIG. 4, or may be due to any other appropriate trigger for raising funds for a milestone.

In step 502, a user of the platform may express a desire to fund a business. In some embodiments, the funder may be responding to the broadcast milestone, or alternatively, the funder may be responding to any other suitable notification of the milestone, such as from another funder or by any other source of information.

In some embodiments, funders may position themselves on a short side of the liability, while businesses may be on a long side. As such, the funder may or may not match the offer of the business, and may instead propose an alternative offer. For example, in step 504, the funder may propose a higher interest rate, to lock in higher returns, in exchange for providing a higher level of funding. If so, then the funder may wait for the business to accept the offer and match funds to cover the offered interest rate.

If the business accepts the higher interest rate in step 510, then in step 512, the new interest rate and funding are used subsequently throughout the milestone. Alternatively, if the business does not accept the higher interest rate in step 510, then the business may continue on to step 506, in which the money received from the funder is matched with the business' liability stored in the holding account. In step 508, the fundraising process may end and the liability and the funding may remain in the holding account until the outcome of the milestone is reported.

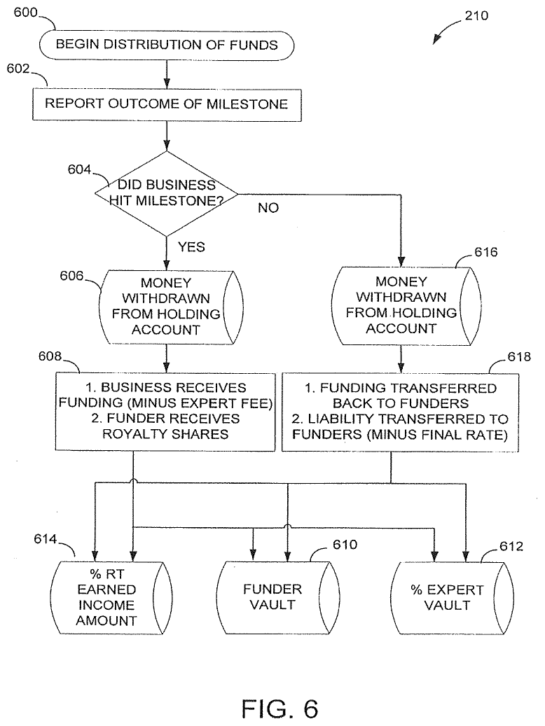

FIG. 6 shows an illustrative embodiment of a flowchart of a computer-implemented method 210 to establish payouts to businesses, experts, and funders. In the embodiment shown, it is assumed that the business has achieved a targeted revenue hurdle by the milestone deadlines. In step 600, the deadline of the milestone may be reached to begin distribution of funds based on the outcome of the milestone, which is broadcast in step 602.

In step 604, it is determined whether the business achieved the milestone. This determination may be made by the expert 104, using whatever qualitative or quantitative criteria was used to establish the milestone. In some embodiments, if the business 102 achieves the milestone, then in step 606, the funding may be withdrawn from the holding account and provided to the business in step 608. Meanwhile, the funders may receive a portion of the business' revenue, in the form of the royalty shares that were issued in the milestone. In some embodiments, the funders may accept this royalty, or alternatively, may let the business reinvest the royalty.

Alternatively, in step 604, if the business 102 does not achieve the milestone, then in step 616, the funding and liability may be withdrawn from the holding account. In some embodiments, in step 618, the funding may be transferred back to the funders, plus an interest taken from the liability offered by the business 102, and stored in the funder vault 610.

In some embodiments, experts may be rewarded with a portion of the rewarded funds and/or a portion of the liability transferred to the funders, which may be stored in the expert vault 612. Furthermore, a host of the platform, such as an expert, may be apportioned a fee from the liability transferred to the funders, which may comprise the final rate in 618, along with the expert's fee. This may be stored in a separate vault 614 for a host.

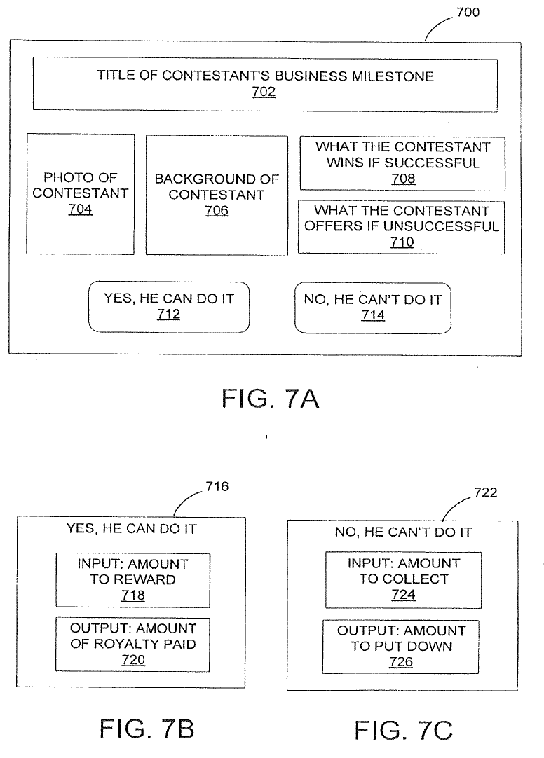

FIG. 7A shows an illustrative embodiment of a portion of a computer-implemented user interface 700 for funders to view information about and select a business to fund. The interface 700 may be designed, for example, to promote usability and emphasize the personal side of the contestant 102. There may be provided a title 702 of the contestant's milestone, a photograph 704 of the contestant, and a background information 706 of the contestant, including work history, education, and relevant past achievements. This background information may provide a broader perspective on the contestant that may help the funder judge the suitability of investing in the contestant. Further, the interface 700 may provide, in component 708, information regarding what the contestant would win if successful, and in component 710, what the contestant offers if fail. In some embodiments, at the bottom of the interface 700, there may be two buttons, button 712 to select if the funder would like to fund the contestant, and button 714 to select, for example, if the funder is uncertain about the contestant's ability to win.

FIG. 7B shows an illustrative embodiment of a portion of a computer-implemented user interface 716 for a user that wants to fund a contestant. This interface 716 may result, for example, from a user selecting button 712 in interface 700. But in general, interface 716 may be generated by any suitable means as an indication that the user intends to fund the contestant's milestone. In some embodiments, the interface 716 may ask the user for an amount to fund in component 718 and, in response, output the amount of royalty paid in component 720.

Alternatively, FIG. 7C shows an illustrative embodiment of a portion of a computer-implemented user interface 722 for a user that may be uncertain about the contestant's ability to win. This interface 722 may result, for example, from a user selecting button 714 in interface 700. But in general, interface 722 may be generated by any suitable means as an indication that the user intends to collect liability from the contestant. In some embodiments, interface 722 may prompt the user, in component 724, for an amount that the user wants to get back if the contestant fails. The system may then calculate how much money the funder needs to provide, based on interest rate that the company is offering. If a user is willing to put down a significant amount of funds to raise in this milestone, then the funder may be eligible for a higher interest rate.

In some embodiments, the amount demanded for failure may allow the system to calculate an output to indicate the amount of funding on short side that must be contributed for a funder to receive back that funding in addition to the calculated output in case of failure. The value calculated may depend on the interest rate determined by the business, the amount of time from when the short side funding is placed, and a deadline.

As noted herein, various financial accounts can be used in connection with implementation of a method and system according to aspects of the invention. A Business Vault (see 412) is a financial account associated with the business from which assets can be drawn and to which assets can be deposited. A Funder Vault (610) is an account in which funders place liquid assets that can be used in conjunction with a financial system as disclosed herein. A holding account is used to store assets put up by the funders. The holding account is also used to store assets reflecting the liability of the business pending determination of the milestone outcome (see 414 and 506). Preferably, the funds in the holding account cannot be accessed until after determination of the milestone at which point the funds will be released to the user or the business depending on whether or not the milestone was reached. Other vault accounts can also be provided to store, e.g., expert fees (612) and platform hosting fees (614).

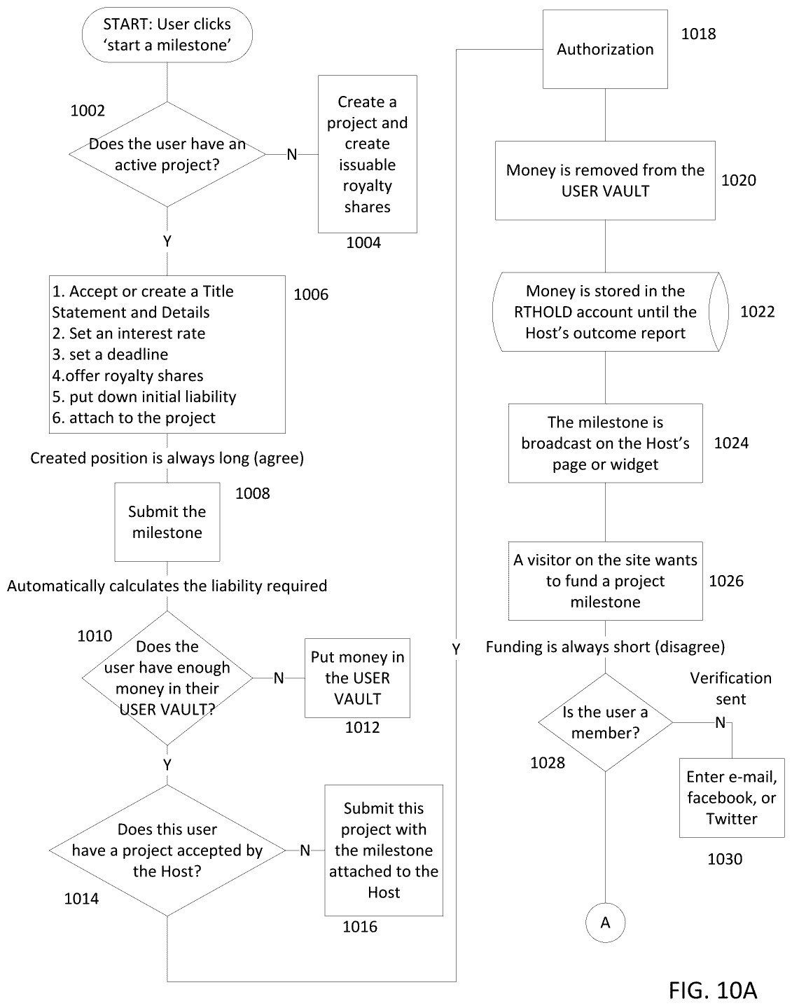

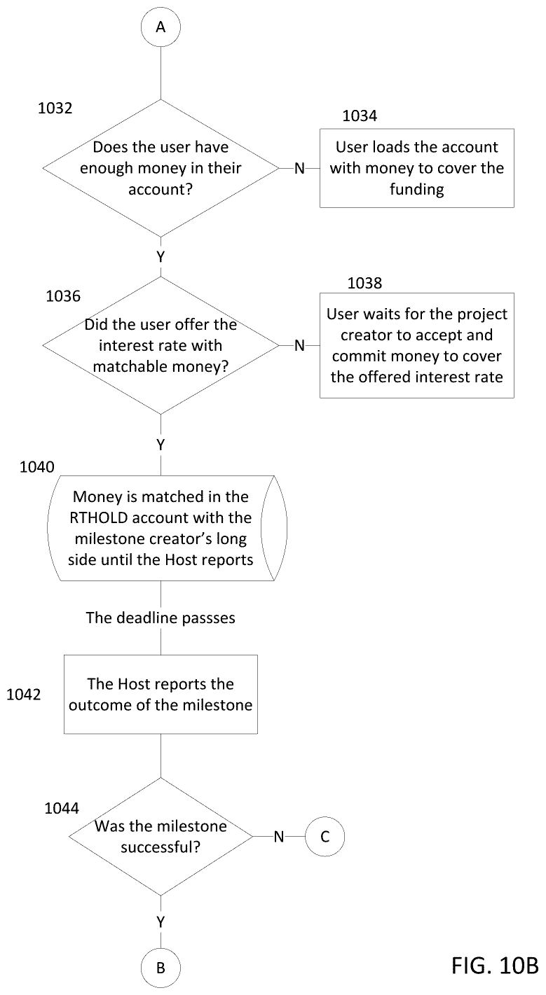

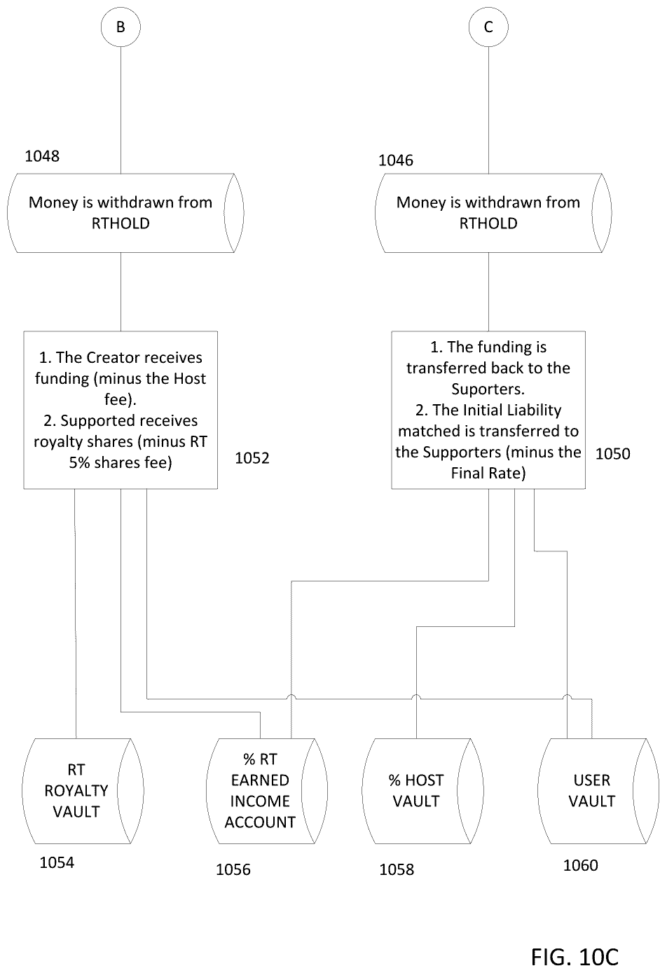

FIGS. 10A-10C show a further illustrative flowchart illustrating a particular method according to one aspect of the invention and further showing the use of various vaults and accounts in a particular implementation of the invention. Both Business and Funder Vaults can be considered types of User Vaults. As generally shown, a business establishes a funding project with a milestone and an associated liability (1002-1008). If the business does not have enough funds in their account to cover the required liability, funds must be added (1010, 1012). The business user can then have the project hosted on a system according to aspects of the invention. (1014, 1016). Once authorization is provided (1018), funds to cover the determined liability are transferred from the business user vault to a holding account where it will remain until the milestone determination is made. (1020, 1022). The funding opportunity is then posted by the host. (1024).

Users who want to fund the account can then access the system (1026-1030) and select a project they want to fund. If they have insufficient funds in their account, funds can be added (1032, 1034). A funding user can offer funding as is or propose an interest rate to with the matchable money. (1036, 1038). Assets from the user's account are then placed into holding account. (1040).

The funding and the liability remain in the holding account, inaccessible to the business or the funders, until the milestone outcome is determined. If the milestone was not reached, the funds in the holding account (both from the funders and the liability funds from the business) are withdrawn and allocated to the funders. (1044, 1046, 1050). If the milestone is reached, the funds in the holding account are released to the business and the funders receive, in this example, royalty bearing shares of the business. (1048, 1052). In addition, whether or not the milestone is reached, some of the funds from the holding account can also be used to cover hosting and expert fees.

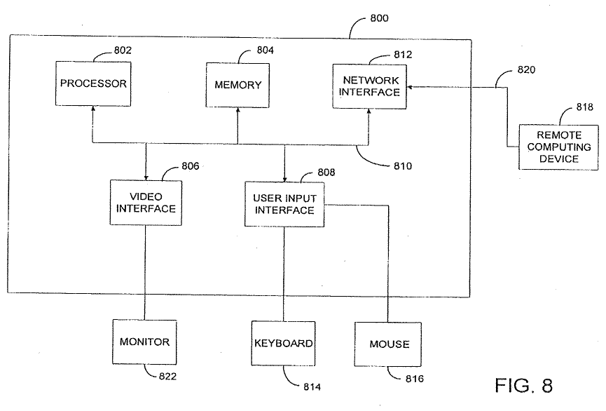

FIG. 8 shows a schematic block diagram of an illustrative computer 800 on which aspects of the invention may be implemented. Only illustrative portions of the computer 800 are identified for purposes of clarity and not to limit aspects of the invention in any way. For example, the computer 800 may include one or more additional volatile or non-volatile memories, one or more additional processors, any other user input devices, and any suitable software or other instructions that may be executed by the computer 800 so as to perform the function described herein.

In the illustrative embodiment, the computer 800 includes a system bus 810, to allow communication between a central processing unit 802, a memory 804, a video interface 806, a user input interface 808, and a network interface 812. The network interface 812 may be connected via network connection 820 to at least one remote computing device 818. Peripherals such as a monitor 822, a keyboard 814, and a mouse 816, in addition to other user input/output devices may also be included in the computer system, as the invention is not limited in this respect.

In some embodiments, one or more techniques for performing a covered action search and/or a semantic search as disclosed herein may be performed by one or more processors included in the same or different computer including, but not limited to, computer 800. For example, the method illustrated in FIG. 1 for performing a covered action search may be executed on a different processor than the technique illustrated in FIG. 4 for performing a semantic search on data stored in accordance with a bias ontology. Additionally, in embodiments where multiple processors are used, the results of one technique performed by a first processor may be transmitted to a second processor to perform a second technique in any suitable way including, but not limited to, transmitting the results across a wired or wireless network, storing the results in a shared database, and physically transferring the results to a second computer on a tangible computer-readable medium.

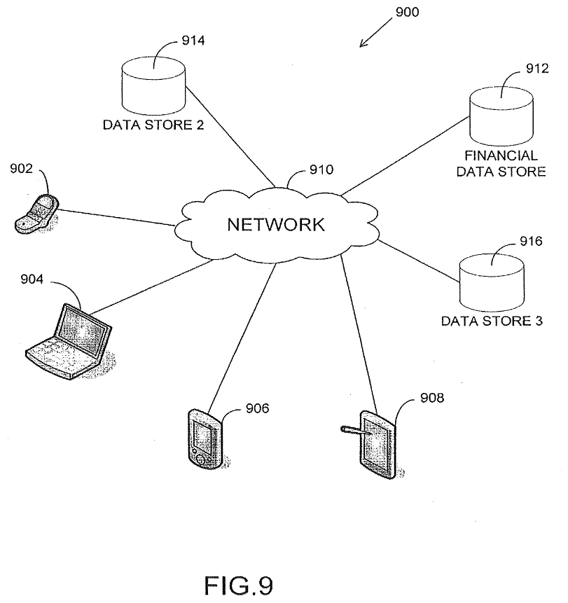

Some embodiments may be used in connection with at least one networked computer system such as the computer system 900 illustrated in FIG. 9. The computer system 900 comprises a plurality of computing devices including, but not limited to cellular phone 902, laptop 904, PDA 906, and tablet computer 908. Each of these computing devices is connected to a plurality of data sets via network 910 using one or more wired or wireless connections. For example, network 910 may be the Internet and each of the computing devices may comprise software and/or hardware configured to access the Internet using one or more wired or wireless connections. The computer system 900 may include a plurality of data stores accessible to network 910 and configured to store data sets comprising disclosure data stored in accordance with a bias ontology as described herein. In some embodiments, the plurality of data stores includes at least one financial data store 912 configured to store financial information for a plurality of agents in an agency relationship. The plurality of data stores may also include data stores (e.g., data store 914 and data store 916) configured to store other information related to potential conflict of interest reporting. Embodiments are not limited by the number of data stores and computing devices in computer system 900. For example, in some embodiments, all computing devices and data stores connected to the Internet may be considered as part of computer system 900.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

1. A computer-based system for improved participation in a project funding contest by (i) a plurality of users able to provide funding and (ii) an entity associated with the project, the system comprising:
a processor-based computer platform having a memory and configured to electronically communicate with remote devices over a network;
at least one data store in communication with the platform and having an entity vault, a plurality of user vaults, and a holding vault defined therein, each respective vault having information stored therein indicating an amount of a designated asset;
the memory having software stored thereon which, when executed, causes the processor to:
present an entity user interface on a display of an entity device;
receive via the entity user interface an input of a milestone, milestone deadline, and funding amount;
automatically determine for the received milestone a proposed liability associated with a failure of the entity to achieve the milestone by the milestone deadline;
initiate a transfer from the entity vault to the holding vault of assets commensurate with the proposed liability;
broadcast the milestone to a plurality of users via a first funder user interface;
for a plurality of respective users, each associated with a respective user device having a display:
(a) present via the network a second funder user interface for display on a respective user device connected to the network, the respective user device associated with a respective user, the software configuring the processor to (i) output information about the entity in an upper portion of the second funder user interface, (ii) output information about the project in a middle area of the second user interface, and (iii) and output in a lower area of the second user interface an input allowing selection by the user of a first option of the milestone being met by a specified deadline and a second option of the milestone not being met by the specified deadline;
(b) present in response to input from the respective user of a selection of the first option a third funder user interface for display on the respective user device and present in response to input from the respective user selection of a selection of the second option a fourth funder user interface for display on the respective user device, wherein the third and fourth funder user interfaces allow entry of a funding offer, the third funder user interface requesting entry of an amount to fund and indicating in response to an entered funding amount a corresponding payout amount if the milestone is met for the entered amount to fund, the fourth funder user interface requesting entry of a desired payout amount and indicating in response to an entered payout amount a corresponding funding amount;
(c) determine based on the proposed liability an amount of accepted liability by the respective user based on receipt of the respective funding offer and output to the respective the respective user device information reflecting the accepted liability;
(d) initiate a transfer from a respective user vault to the holding vault, the respective user vault associated the respective user, of assets commensurate with the respective funding offer from the respective user vault;
determine whether the entity has achieved the milestone by the respective deadline;
in response to a determination that the entity has not achieved the milestone initiate a transfer from the holding vault to each respective user vault of assets commensurate with the respective funding offer of the respective user and of assets commensurate with the respective accepted liability for the funding offer of the respective user; and
in response to a determination that the entity has achieved the milestone by the respective deadline initiate a transfer from the holding vault to the entity vault of at least a portion of the assets commensurate with the funding offer from each of the respective users associated with the milestone and funds commensurate with each respective accepted liability.
